(19) United States
(12) Patent Application Publication
(10) Pub. No.: US 2019/0129242 A1
(43) Pub. Date: May 2, 2019

(54) DISPLAY DEVICE

(71) Applicant: Samsung Display Co. Ltd., Yongin-si (KR)

(72) Inventors: Sang Il PARK, Seoul (KR); Yeun Tae KIM, Hwaseong-si (KR); Min Wook PARK, Asan-si (KR); Jin Su LEE, Suwon-si (KR); Kun Wook HAN, Seongnam-si (KR)

(21) Appl. No.: 16/163,584

(22) Filed: Oct. 18, 2018

(30) Foreign Application Priority Data
Oct. 31, 2017 (KR) 10-2017-0143333

(51) Int. Cl. G02F 1/1335

(52) U.S. Cl. CPC G02F 1/133514

(57) ABSTRACT

A display device including a first substrate having a first surface including a display area and a non-display area disposed outside of the display area, the display area comprising a plurality of pixels, a plurality of color filters disposed on the first surface of the first substrate, and an organic film disposed to cover the color filters. The color filters include first, second, and third color filters corresponding to the pixels and disposed in the display area, a fourth color filter disposed in the non-display area, and a fifth color filter disposed on the fourth color filter, in which at least one of the fourth and fifth color filters is spaced apart from the display area.

### CROSS-REFERENCE TO RELATED APPLICATION

This application claims priority from and the benefit of Korean Patent Application No. 10-2017-0143333, filed on Oct. 31, 2017, which is hereby incorporated by reference for all purposes as if fully set forth herein.

### BACKGROUND

### Field

Exemplary embodiments relate to a display device.

### Discussion of the Background

Display devices have become increasingly important with the developments of multimedia technology. Accordingly, various types of display devices, such as a liquid crystal display (LCD) device, an organic light-emitting display device, etc. have been used.

The LCD device, which is one of the most widely used display devices today, controls the amount of light transmitted therethrough by applying voltages to electrodes (e.g., pixel electrodes and a common electrode) formed on two substrates facing each other to control the alignment of liquid crystal molecules in a liquid crystal layer interposed between the two substrates.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device capable of preventing defects such as edge stains.

Additional aspects will be set forth in the detailed description which follows, and, in part, will be apparent from the disclosure, or may be learned by practice of the inventive concept.

According to an exemplary embodiment, a display device includes a first substrate having a first surface including a display area and a non-display area disposed outside of the display area, the display area including a plurality of pixels, a plurality of color filters disposed on the first surface of the first substrate, and an organic film disposed to cover the color filters. The color filters include first, second, and third color filters corresponding to the pixels and disposed in the display area, a fourth color filter disposed in the non-display area, and a fifth color filter disposed on the fourth color filter, in which at least one of the fourth and fifth color filters is spaced apart from the display area.

According to an exemplary embodiment, a display device includes a first substrate having a first surface including a display area and a non-display area disposed outside the display area, the display area including a plurality of pixels, a plurality of color filters disposed on the first surface of the first substrate, an organic film disposed to cover the color filters, and a metal layer disposed between the first substrate and the color filters. The color filters include first, second, and third color filters corresponding to the pixels and disposed in the display area, a fourth color filter disposed in the non-display area, and a fifth color filter disposed on the fourth color filter, in which the metal layer is disposed below the fourth color filter and is spaced apart from the display area.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic view illustrating the planar structure of a display device according to an exemplary embodiment.

FIG. 2 is a cross-sectional view taken along line II-II′ of FIG. 1.

FIG. 3, FIG. 4, FIG. 5, FIG. 6, and FIG. 7 are cross-sectional views of display devices according to exemplary embodiments.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. The regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

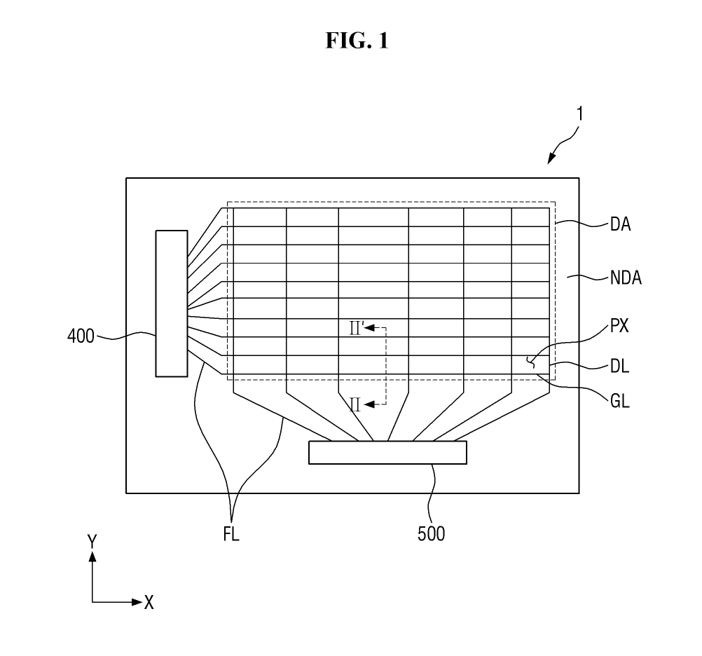

FIG. 1 is a schematic view illustrating the planar structure of a display device according to an exemplary embodiment.

Referring to FIG. 1, a display device 1 includes a plurality of gate lines GL, which extend in a first direction X, and a plurality of data lines DL, which extend in a second direction Y perpendicular to the first direction X. The gate lines GL and the data lines DL may be disposed to intersect each other, and define a plurality of pixels PX arranged in a matrix form.

The display device 1 has a display area DA, in which the pixels PX are defined, and a non-display area NDA disposed outside of the display area DA. The non-display area NDA is an area in which the pixels PX are not defined and may surround the display area DA. The display area DA is an area in which an image output by the pixels PX is displayed, and the non-display area NDA is an area in which no image is displayed.

In the non-display area NDA, a gate driver 400 for providing signals to the gate lines GL and a data driver 500 for providing signals to the data lines DL may be disposed. Also, in the non-display area NDA, fan-out lines FL for transmitting signals from the gate driver 400 and the data driver 500 to the gate lines GL and the data lines DL may be disposed.

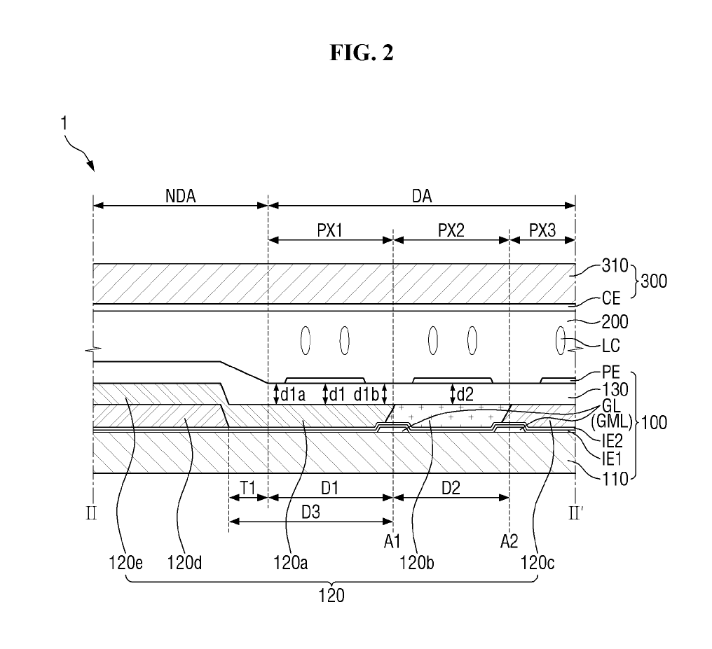

FIG. 2 is a cross-sectional view taken along line II-II′ of FIG. 1. More particularly, FIG. 2 illustrates the cross-sectional structure of the display device 1 in a region ranging from the non-display area NDA to a part of the display area DA including first, second, and third pixels PX1, PX2, and PX3.

Referring to FIG. 2, the display device 1 includes a first display panel 100, a second display panel 300 facing the first display panel 100, and a liquid crystal layer 200 interposed between the first and second display panels 100 and 300.

The first display panel 100 may be a panel on which switching elements, such as thin-film transistors (TFTs) for driving liquid crystal molecules LC in the liquid crystal layer 200, and pixel electrodes PE are formed. Specifically, the first display panel 100 may include a first substrate 110, a gate metal layer GML, a first insulating film IE1, a second insulating film IE2, a plurality of color filters 120, an organic film 130, and pixel electrodes PE.

The first substrate 110 may include a material having heat resistance and transparency. For example, the first substrate 110 may be formed of a transparent glass or plastic material, but the inventive concepts are not limited thereto. The display area DA and the non-display area NDA may be defined on one surface of the first substrate 110, for example, on the top surface of the first substrate 110.

The gate metal layer GML may be disposed on the first substrate 110. The gate metal layer GML may include the gate lines GL. The gate lines GL may be disposed in the display area DA along the boundaries between the first, second, and third pixels PX1, PX2, and PX3. That is, as described above, the gate lines GL and the data lines DL may divide the display area DA into the pixels PX.

The gate metal layer GML may further include metal patterns that include the same material as the gate lines GL, such as, gate electrodes. That is, the gate metal layer GML may be a layer having particular metal patterns formed on the first substrate 110.

For example, a buffer layer (not illustrated) may be further disposed on the first substrate 110, and the gate metal layer GML may be disposed on the buffer layer. However, the inventive concepts are not limited to this example.

The first insulating film IE1 may be disposed on the first substrate 110 and cover the gate metal layer GML. The second insulating film IE2 may be disposed on the first insulating film IE1. Although not specifically shown, a semiconductor layer and a data metal layer including the data lines DL may be disposed between the first and second insulating films IE1 and IE2 and covered by the second insulating film IE2.

The first and second insulating films IE1 and IE2 may include at least one of an inorganic insulating material, such as silicon oxide (SiOₓ) or silicon nitride (SiNₓ), and an organic insulating material, such as benzocyclobutene (BCB), an acrylic material, or polyimide (PI), but the inventive concepts are not limited thereto. That is, the material of the first and second insulating films IE1 and IE2 is not particularly limited. Also, the first and second insulating materials IE1 and IE2 may include the same material or different materials.

The color filters 120 may be disposed on the second insulating film IE2. Each of the color filters 120 may include an organic material having a particular color. The color filters 120 may filter light emitted from a backlight unit (not illustrated) and allow each of the first, second, and third pixels PX1, PX2, and PX3 to realize a particular color.

The color filters 120 may be disposed not only in the display area DA, but also in the non-display area NDA. The color filters 120 may include first, second, and third color filters 120a, 120b, and 120c disposed in the display area DA, and fourth and fifth color filters 120d and 120e disposed in the non-display area NDA. Among the first, second, and third color filters 120a, 120b, and 120c, the first color filter 120a may be disposed closest to the non-display area NDA, and the third color filter 120c may be disposed furthest from the non-display area NDA.

The first, second, and third color filters 120a, 120b, and 120c may be disposed to correspond to the first, second, and third pixels PX1, PX2, and PX3, respectively. That is, the first color filter 120a may be disposed in the first pixel PX1 adjacent to the non-display area NDA, the second color filter 120b may be disposed in the second pixel PX2 adjacent to the first pixel PX1, and the third color filter 120c may be disposed in the third pixel PX3 adjacent to the second pixel PX2. Referring to FIG. 1, the color filters 120 may be arranged such that the first, second, and third color filters 120a, 120b, and 120c are sequentially repeated for every three pixels along the second direction Y, and one of the first, second, and third color filters 120a, 120b, and 120c is repeated along the first direction X, but the inventive concepts are not limited thereto. For example, the color filters 120 may be arranged such that the first, second, and third color filters 120a, 120b, and 120c may be sequentially repeated for every three pixels along the first direction X, and only one of the first, second, and third color filters 120a, 120b, and 120c is repeated along the second direction Y. In addition, at least four or more types of color filters 120 may be provided and repeatedly arranged in the manner described above.

Each of the first, second, and third color filters 120a, 120b, and 120c may display one of primary colors, such as three primary colors of red, green, and blue, but the inventive concepts are not limited thereto. For example, each of the first, second, and third color filters 120a, 120b, and 120c may display one of cyan, magenta, yellow, and white colors. The first, second, and third color filters 120a, 120b, and 120c will hereinafter be described as blue, green, and red color filters, respectively, but the inventive concepts are not limited thereto.

The fourth color filter 120d may be spaced apart from the display area DA. Specifically, the fourth color filter 120d may be spaced apart by a predetermined distance T1 from the boundary between the display area DA and the non-display area NDA.

Accordingly, a distance D3 from the boundary between the first and second pixels PX1 and PX2, i.e., a first boundary A1, which is the boundary between the first and second color filters 120a and 120b, to the fourth color filter 120d may be greater than a distance D2 from the first boundary A1 to the boundary between the second and third pixels PX2 and PX3, i.e., a second boundary A2, which is the boundary between the second and third color filters 120b and 120c. Sizes of the first and second pixels PX1 and PX2 are substantially the same, but since the fourth color filter 120d is spaced apart by the predetermined distance T1 from the display area DA, the distance D3 between the first boundary A1 and the fourth color filter 120d may be greater than the distance D2 between the first and second boundaries A1 and A2 by the predetermined distance T1.

The fifth color filter 120e may be disposed on the second insulating film IE2 and cover the fourth color filter 120d. Since the fourth color filter 120d is spaced apart from the display area DA, the fifth color filter 120e may be disposed in a region where the fourth color filter 120d is not disposed as shown in FIG. 2. Accordingly, a portion of the fifth color filter 120e not overlapping the fourth color filter 120d may be formed closer to the first substrate 110 that a portion of the fifth color filter 120d overlapping the fourth color filter 120d.

The fourth color filter 120d may have the same color as the third color filter 120d (e.g., a red color filter), and the fifth color filter 120e may have the same color as the first color filter 120a (e.g., a blue color filter). The fifth color filter 120e may be integrally formed with the first color filter 120a. That is, the first and fifth color filters 120a and 120e may be formed at the same time as a single color filter layer by the same process.

The color filters 120 may be formed in the order of the third and fourth color filters 120c and 120d, which may be red color filters, the second color filter 120b, which may be a green color filter, and the first and fifth color filters 120a and 120e, which may be blue color filters. As described above, the first and fifth color filters 120a and 120e may be integrally formed as a single color filter layer.

The organic film 130 may be disposed on the color filters 120. The organic film 130 may be disposed on the entire display area DA and the entire non-display area NDA and cover the color filters 120.

The thickness of the organic film 130 may be substantially uniform in the first pixel PX1. Specifically, a thickness d1a of the organic film 130 in a portion of the first pixel PX1 adjacent to the non-display area NDA may be substantially the same as a thickness d1b of the organic film 130 in a portion of the first pixel PX1 distant from the non-display area NDA, or an average thickness d1 of the organic film 130 in the first pixel PX1. The thickness d1a of the organic film 130 may also be substantially the same as an average thickness d2 of the organic film 130 in the second pixel PX2.

In the display area DA, the organic film 130 may be disposed on the first, second, and third color filters 120a, 120b, and 120c, which are arranged side-by-side horizontally. In the non-display area NDA, however, the organic film 130 may be disposed on a stack of the fourth and fifth color filters 120d and 120e. Accordingly, the top surface of the organic film 130 may become higher along a direction from the display area DA to the non-display area NDA, which may cause thickness irregularities in the first pixel PX1 adjacent to the non-display area NDA that may cause defects, such as edge stains.

The display device 1 according to an exemplary embodiment includes the fourth color filter 120d spaced apart from the display area DA by the predetermined distance T1. Accordingly, among the color filters 120, only the fifth color filter 120e may be disposed in a region adjacent to the display area DA as a single layer. Accordingly, the top surface of the fifth color filter 120e may be lowered in the region adjacent to the display area DA, such that the height of the organic film 130 increases gently along a direction from the display area DA to the non-display area NDA. Therefore, the organic film 130 in the first pixel PX1 adjacent to the non-display area NDA may have a uniform thickness.

The organic film 130 may include an organic insulating material, such as BCB, an acrylic material, or PI, but the material of the organic film 130 is not particularly limited.

The pixel electrodes PE may be disposed on the organic film 130. The pixel electrodes PE may be disposed in the first, second, and third pixels PX1, PX2, and PX3, respectively. The pixel electrodes PE may include a transparent conductive material. For example, the pixel electrodes PE may include a metal oxide, such as indium zinc oxide (IZO), indium tin oxide (ITO), tin oxide, or zinc oxide.

The second display panel 300 may include a second substrate 310 and a common electrode CE. The second substrate 310 may be formed of a transparent glass or plastic material.

The common electrode CE may be disposed on one surface of the second substrate 310. Specifically, the common electrode CE may be disposed on the bottom surface of the second substrate 310 and face the pixel electrodes PE. The common electrode CE may be disposed on the entire display area DA and the entire non-display area NDA. The common electrode 210 may be formed of a transparent conductive material, such as ITO or IZO.

The liquid crystal layer 200 is interposed between the first and second display panels 100 and 300. The liquid crystal molecules LC of the liquid crystal layer 200 are illustrated as being disposed only in the display area DA, but the inventive concepts are not limited thereto. That is, some of the liquid crystal molecules LC may be disposed in the non-display area NDA.

The display device 1 may further include a sealing member, spacers, an alignment film, and the like between the first and second display panels 100 and 300.

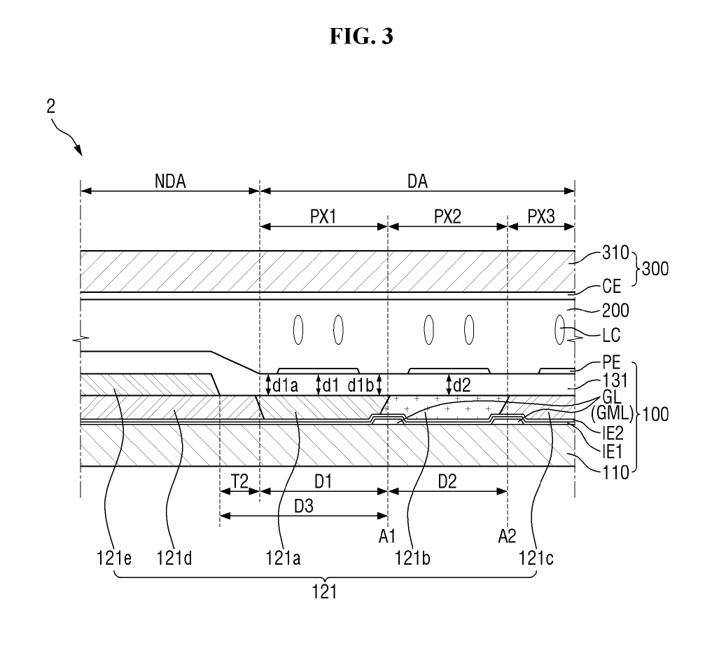

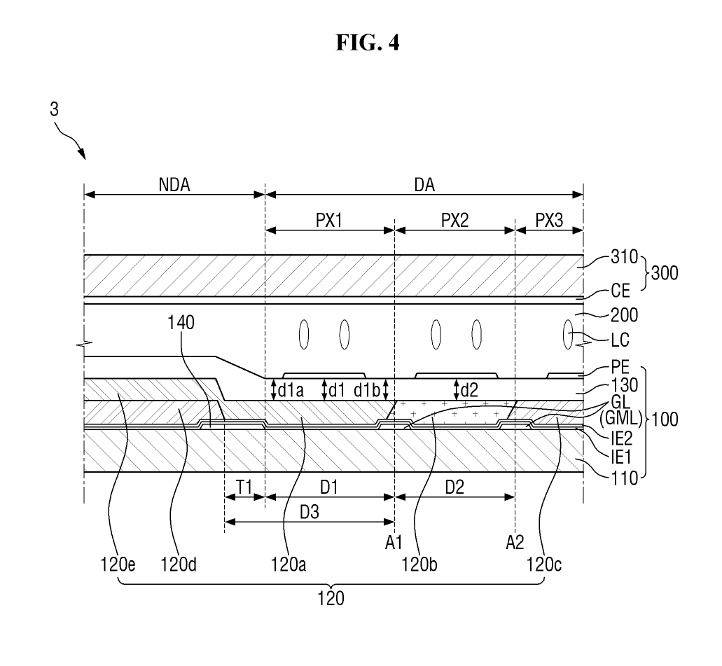

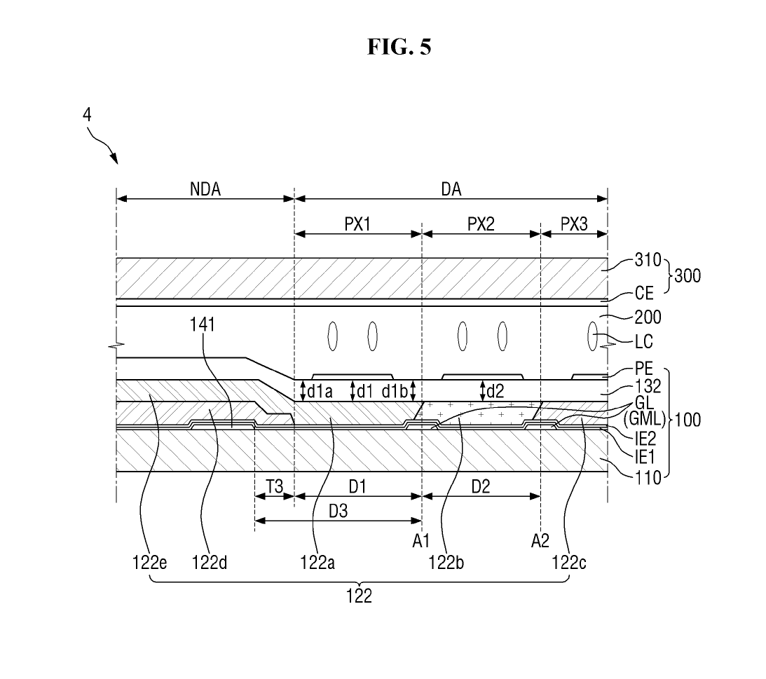

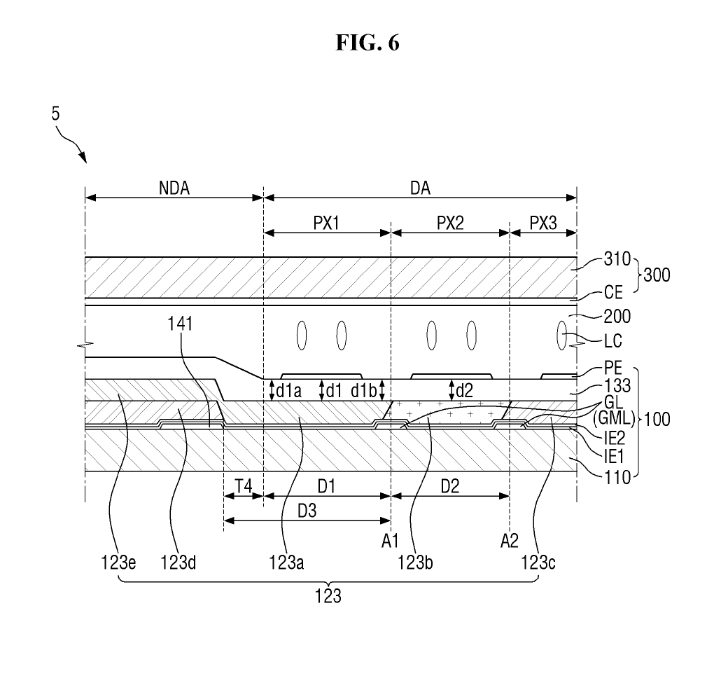

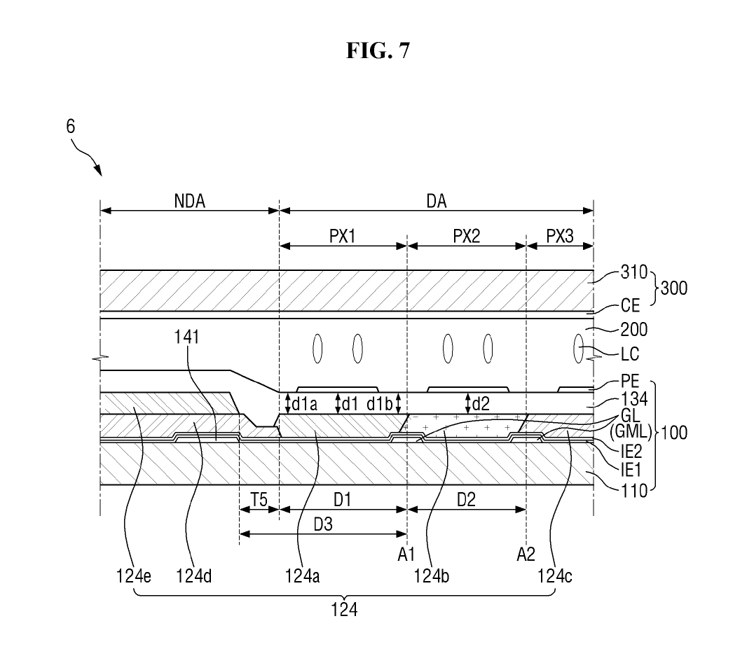

FIG. 3 is a cross-sectional view of a display device according to another exemplary embodiment.

A display device 2 of FIG. 3 is substantially the same as the display device 1 of FIGS. 1 and 2, except that a fifth color filter 121e, instead of a fourth color filter 121d, is spaced apart from the display area DA by a predetermined distance T2. Accordingly, repeated description of the same elements of the display device 2 will be omitted.

Referring to FIG. 3, the fourth color filter 121d may be disposed adjacent to a first color filter 121a disposed in a first pixel PX1, and the fifth color filter 121e may be spaced apart from the display area DA by the predetermined distance T2. In other words, the fifth color filter 121e may be spaced apart from a first color filter 121a by the predetermined distance T2. The fourth color filter 121d may be disposed to directly adjoin the first color filter 121a, but inventive concepts are not limited thereto.

Since only the fourth color filter 121d is provided in a region adjacent to the display area DA as a single layer, an organic film 131 may have a uniform thickness in the first pixel PX1.

FIG. 4 is a cross-sectional view of a display device according to another exemplary embodiment.

A display device 3 of FIG. 4 is substantially the same as the display device 1 of FIGS. 1 and 2, except that the display device 3 further includes a metal layer 140 below a fourth color filter 120d in a non-display area NDA. Accordingly, repeated description of the same elements of the display device 3 will be omitted.

Referring to FIG. 4, the metal layer 140 may be disposed below the fourth color filter 120d in the non-display area NDA. The metal layer 140 may adjoin the boundary between a display area DA and the non-display area NDA.

The metal layer 140 may be a part of a gate metal layer GML. Specifically, the metal layer 140 may be a pattern layer of the gate metal layer GML, and may be disposed in the non-display area NDA along with other pattern layers of the gate metal layer GML, such as fan-out lines, wiring for inspection, and the like. Alternatively, the metal layer 140 may be a part of a data metal layer (not illustrated), rather than a part of the gate metal layer GML. That is, the type of the metal layer 140 is not particularly limited as long as the metal layer 140 including metal is disposed in a portion of the non-display area NDA adjacent to the display area DA.

The metal layer 140 is relatively thinner than the color filters 120. Thus, even if the metal layer 140 is disposed adjacent to the display area DA, as illustrated in FIG. 4, an organic film 130 can be formed to have a uniform thickness in a first pixel PX1, because a fourth color filter 120d is spaced apart from the display area DA by the predetermined distance T1.

FIG. 5 is a cross-sectional view of a display device according to another exemplary embodiment.

A display device 4 of FIG. 5 is substantially the same as the display device 1 of FIGS. 1 and 2, except that a metal layer 141, instead of a fourth color filter 121d, is spaced apart from a display area DA by a predetermined distance T3. Accordingly, repeated description of the same elements of the display device 4 will be omitted.

Referring to FIG. 5, the fourth color filter 122d may be disposed adjacent to a first color filter 122a disposed in a first pixel PX1, and the metal layer 141 may be spaced apart from the display area DA by the predetermined distance T3.

That is, even if the metal layer 141 is disposed below the fourth color filter 122d, an organic film 132 can be formed to have a uniform thickness because the metal layer 141, instead of the fourth color filter 122d, is spaced apart from the display area DA.

FIG. 6 is a cross-sectional view of a display device according to another exemplary embodiment.

A display device 5 of FIG. 6 is substantially the same as the display device 3 of FIG. 4, except that a metal layer 141 and a fourth color filter 123d are both spaced apart from a display area DA by a predetermined distance T4. Accordingly, repeated description of the same elements of the display device 5 will be omitted.

Referring to FIG. 6, the metal layer 141 and the fourth color filter 123d may both be spaced apart from the display area DA by the predetermined distance T4. In this manner, the thickness of a stack of the metal layer 141 and color filters 123 may be reduced, and thus, an organic film 133 may be formed to have a uniform thickness in a first pixel PX1.

The distance by which the metal layer 141 is spaced apart from the display area DA and the distance by which the fourth color filter 123d is spaced apart from the display area DA may be the same, but the inventive concepts are not limited thereto. That is, alternatively, the distance between the metal layer 141 and the display area DA may be different from the distance between the fourth color filter 123d and the display area DA.

FIG. 7 is a cross-sectional view of a display device according to another exemplary embodiment.

A display device 6 of FIG. 7 is substantially the same as the display device 4 of FIG. 5, except that a metal layer 141 and a fifth color filter 123e are both spaced apart from a display area DA by a predetermined distance T5. Accordingly, repeated description of the same elements of the display device 6 will be omitted.

Referring to FIG. 7, the metal layer 141 and the fifth color filter 123e may both be spaced apart from the display area DA by the predetermined distance T5. In other words, the fifth color filter 124e may be spaced apart from a first color filter 124a by the predetermined distance T5. A fourth color filter 124d may be disposed to directly adjoin the first color filter 124a, but the inventive concepts are not limited thereto. In this manner, the thickness of a stack of the metal layer 141 and color filters 124 may be reduced, and thus, an organic film 134 may be formed to have a uniform thickness in a first pixel PX1.

The distance by which the metal layer 141 is spaced apart from the display area DA and the distance by which the fifth color filter 123e is spaced apart from the display area DA may be the same, but the inventive concepts are not limited thereto. That is, alternatively, the distance between the metal layer 141 and the display area DA may be different from the distance between the fifth color filter 123e and the display area DA.

According to exemplary embodiments of the present invention, an organic film may be formed to have a uniform thickness, even on the color filters of outer pixels, which may prevent defects, such as edge stains.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device comprising:
a first substrate having a first surface comprising a display area and a non-display area disposed outside of the display area, the display area comprising a plurality of pixels;
a plurality of color filters disposed on the first surface of the first substrate; and
an organic film disposed to cover the color filters,
wherein:
the color filters comprise:
first, second, and third color filters corresponding to the pixels and disposed in the display area;
a fourth color filter disposed in the non-display area; and
a fifth color filter disposed on the fourth color filter; and
at least one of the fourth and fifth color filters is spaced apart from the display area.

2. The display device of claim 1, wherein:
the fifth color filter covers the fourth color filter; and
the fourth color filter is spaced apart from the display area.

3. The display device of claim 2, wherein:
the first, second, and third color filters are sequentially disposed adjacent to the non-display area; and
a first distance from a boundary between the first and second color filters to the fourth color filter is greater than a second distance from the boundary between the first and second color filters to a boundary between the second and third color filters.

4. The display device of claim 1, wherein the fifth color filter covers a portion of the fourth color filter and is spaced apart from the display area.

5. The display device of claim 4, wherein:
the first, second, and third color filters are sequentially disposed adjacent to the non-display area; and
a distance from a boundary between the first and second color filters to the fifth color filter is greater than a distance from the boundary between the first and second color filters to a boundary between the second and third color filters.

6. The display device of claim 4, wherein:
the first, second, and third color filters are sequentially disposed adjacent to the non-display area; and
a distance from a boundary between the first and second color filters to the fourth color filter is substantially the same as a distance from the boundary between the first and second color filters to a boundary between the second and third color filters.

7. The display device of claim 1, wherein one of the first, second, and third color filters adjacent to the non-display area is integrally formed with the fifth color filter.

8. The display device of claim 1, wherein:
the fourth color filter is a red color filter; and
the first and fifth color filters are blue color filters.

9. The display device of claim 1, wherein the organic film has a substantially uniform thickness in a pixel adjacent to the non-display area.

10. The display device of claim 1, further comprising a metal layer disposed between the first substrate and the fourth color filter.

11. The display device of claim 10, wherein the metal layer is spaced apart from the display area.

12. The display device of claim 1, wherein the first, second, and third color filters are repeatedly arranged to correspond to the pixels.

13. A display device comprising:
a first substrate having a first surface comprising a display area and a non-display area disposed outside the display area, the display area comprising a plurality of pixels;
a plurality of color filters disposed on the first surface of the first substrate;
an organic film disposed to cover the color filters; and
a metal layer disposed between the first substrate and the color filters,
wherein:
the color filters comprise:
first, second, and third color filters corresponding to the pixels and disposed in the display area;
a fourth color filter disposed in the non-display area; and
a fifth color filter disposed on the fourth color filter; and
the metal layer is disposed below the fourth color filter and is spaced apart from the display area.

14. The display device of claim 13, wherein the metal layer comprises a gate metal or a data metal.

15. The display device of claim 13, wherein the metal layer is spaced apart from one of the first, second, and third color filters adjacent to the non-display area.

16. The display device of claim 13, wherein:
the first, second, and third color filters are sequentially disposed adjacent to the non-display area; and
a distance from a boundary between the first and second color filters to the metal layer is greater than a distance from the boundary between the first and second color filters to a boundary between the second and third color filters.

17. The display device of claim 13, wherein:
the first, second, and third color filters are sequentially disposed adjacent to the non-display area; and
a distance from a boundary between the first and second color filters to the fourth color filter is substantially the same as a distance from the boundary between the first and second color filters to a boundary between the second and third color filters.

18. The display device of claim 13, wherein:
the fifth color filter is disposed to cover the fourth color filter; and
the fourth color filter is spaced apart from the display area.

19. The display device of claim 13, wherein the fifth color filter is disposed to cover a portion of the fourth color filter and is spaced apart from the display area.

20. The display device of claim 13, wherein the first, second, and third color filters are repeatedly arranged to correspond to the pixels.
